(19) United States
(12) Patent Application Publication
(10) Pub. No.: US 2010/0076976 A1
(43) Pub. Date: Mar. 25, 2010

(54) Method of Automatically Tagging Image Data

(76) Inventors: Zlatko Manolov Sotirov, Santa Clara, CA (US); Stilian Ivanon Pandev, santa Clara, CA (US)

Correspondence Address: Zlatko M. Sotirov, 1901 Fraser Pl, Santa Clara, CA, 95050, US

(21) Appl. No.: 12/205,866

(22) Filed: Sep. 6, 2008

(51) Int. Cl. G06F 17/30

(52) U.S. Cl. 707/737; 707/E17.019

(57) ABSTRACT

The present invention provides a method of automatic tagging of image data taken at geographical locations, which represent points of interest (POI). In addition to the image data, each image file contains image metadata, which is structured information about the image data resources. The metadata of a POI includes its title, description, associated keywords, geographical identification data, etc., and it describes the POI as a resource of information. Each POI has its unique identifier that connects it to a record in a database, which contains the metadata of a plurality of POIs. The auto-tagging method, subject to the present invention, identifies the POI where image data has been taken. It then retrieves POI metadata from the database or reads it directly from an information tag placed within the POI, and assigns this metadata to all the image files containing image data taken at the POI. In particular, this invention focuses on barcode representation of the unique POI identifier (UPIID) and of its metadata (if the metadata is read directly during the image taking process). The implementation of this method does not require additional devices for location detection (such as GPS), and is applicable to all digital cameras regardless of type and complexity.

### FIELD OF THE INVENTION

The present invention applies to digital image processing, and namely to the automation of the process of assigning location-specific metadata attributes to digital images.

### BACKGROUND OF THE INVENTION

Nowadays, due to the advances in digital photography, the affordability of digital cameras and the low cost of memory, people take a vast amount of photographs, averaging tens of thousands of photographs per family, per year. In most cases people store their photographs on their computers without taking the time to organize and label them accordingly. Even if at a later time they decide to go back and organize their photos, the information about where the photographs were taken has either been lost, or has become very difficult to retrieve. As a result, the amount of non-organized pictures builds up, and the most that can be done in terms of organization is to group pictures under a common folder name. The lack of titles and descriptions creates inconveniences when sharing pictures with other people through photo sharing sites such as Flickr, Google photos, etc. This problem can be remedied through the use of photo metadata, which was created by The International Press Telecommunications Council (IPTC) in 1990 as a part of the Information Interchange Model (IIM) standard. According to IPTC, structured information about image resources, such as image name, location, quality and relationship to other objects in the collection, is called photo metadata, and is essential for identifying and managing digital assets such as images. As mentioned above, photographs that do not contain metadata, adversely affect everyone working with digital images; resources are wasted, opportunities are lost, liability increases and intellectual property rights are eroded. Lack of image metadata can delay projects, requiring additional research to confirm caption details and establish rights and permissions. This contributes to the growing problem of image misuse, whether by error or intent.

This is where the natural need to acquire location information during the process of taking photographs, and to assign location specific metadata to the photographs, comes in. Currently, in order to provide location services for the purpose of automating location tag creation for images, a digital camera must have some sort of location sensors, such as a GPS receiver or a cell phone with location detection. The GPS or other location codes are stored in the image as tags, for later retrieval. A dedicated application can then analyze the image and retrieve the tags from a dedicated central database and attach them to the image file.

An available example of such a system is the Caplio Pro G3 digital camera by Ricoh, shown in FIG. 1P, which is capable of automatic image geo-coding. The Caplio Pro G3 is a high-resolution digital camera that embeds GPS coordinate information into captured images. This information is received from either its on-board GPS unit or from external GPS devices. Once these captured ‘geo-images’ are transferred to a PC, they are automatically converted to shape files or merged to geo-databases for instant integration into Geographic Information Systems (GIS). Points representing each image's position may be hovered over to display a thumbnail, or clicked on to access the full-size image. In addition to storing GPS data in the image, the camera also utilizes a user-configurable data dictionary for tagging pictures with workflow-related information. The user may also insert a Compact Flash WiFi 802.1ib card into the camera, for the purpose of downloading the images from the camera to a PC or PDA, via FTP or e-mail through a wireless communication.

Another example of a system that records the position where photographs are taken is Sony's GPS-CS1, shown in FIG. 2P. It is a small (9 cm/3.5 in) cylindrical device attached to the camera or the belt loop and carried all the time while photographs are taken. It records GPS location information, which can later be synchronized with the digital images to provide a map of where the photos were taken. GPS-CS1 does this by using date and time information stored in the image header, which requires the camera's clock to be synchronized. The mapping solution is an online website with maps provided by Google Maps and the synchronization software writes the GPS location into JPEG EXIF headers.

Another method for establishing a location for a digital image using local networks rather than GPS units, is provided by E. Anderson and R. Morris (FIG. 3P). Aspects of the invention include the broadcasting of a location identifier (ID) that identifies a network location, over a network (14); the detection of the location ID of a digital image capture device coupled to the network, by the network interface (34); and in regards to the image capture device, the capturing of a digital image when in communication with the network, and the association of the location ID with the digital image. The location ID broadcast over the network includes a network ID. After the mobile device captures a digital image while in communication with the network, the network ID is sent to an online location information service, which looks up the location of the network based on the network ID. The location information is then returned for association with the digital image, preferably as a location tag. The system may also provide a specific description tag describing the contents of the images by matching uploaded captured images to reference images captured within the same network, and using description tags saved with the reference images to automatically tag the uploaded images.

Although the integration of a GPS unit into the camera eliminates the need for the user to carry a separate GPS unit, the use of GPS units with handheld digital image capture devices still has several disadvantages. These include the units being bulky, expensive, and energy inefficient. For example, as FIG. 1P illustrates the Ricoh camera has an attached GPS CompactFlash card. As shown, the GPS CompactFlash card 20 inserted into the Ricoh camera 10 extends well outside of the camera housing, making it unwieldy to use. In addition, the Ricoh camera/GPS/software bundle lists for approximately $1000, with the GPS card 20 contributing $160. It is hard to say how many users will be willing to pay such a price to attach location tags to their images. Sony's GPS-CS1 adds at least $150 to the cost of the digital camera it is attached to. As the price of digital cameras goes down, the price of the GPS device becomes comparable with the price of the camera.

The use of local networks to identify the location of a digital image does not require a GPS. It does however require the availability of a wireless network 14 at the place where the image is taken and a network interface 34 in the image capturing device. This requirement automatically makes this approach inapplicable to the majority of digital cameras in use nowadays.

Regardless of the fact that advances in digital and communication technology have made GPS devices smaller, cheaper, and easier to integrate into handheld digital capture devices, and more and more wireless networks now exist at the points of interest, there is still a need for a method that would allow the owner of any digital camera to tag her/his images with location specific information, without GPS or local network existence requirements. The present invention addresses such a need.

### BRIEF SUMMARY OF THE INVENTION

To address the need above, the present invention provides a method of automatically assigning metadata to digital images, taken at a specific POI. Each POI is assigned a unique identifier (UPOIID), which is represented in a physical form and placed in such a way that it can be accessed and captured by an image capturing apparatus. The metadata of a POI includes its title, description, associated keywords, geographical identification data, etc., and it describes the POI as a resource of information. The metadata of a plurality of POIs is organized in a publicly accessible database. The records in the database are identified by the UPOIID. The auto-tagging application, which implements the method of the present invention, processes all the images taken at a specific POI, recognizes the image of the UPOIID, decodes it and obtains the UPOIID. After determining which images have been taken at one and the same POI, the application retrieves the POI metadata from the database and assigns it to the images taken at the POI. The images are stored in a host device, which runs the auto-tagging application and accesses the database (which resides in a remote device), through a communication network.

In one embodiment of the present invention, the auto-tagging application resides and runs in an image capturing apparatus that is coupled to the communication network and is capable of recognizing the UPOIID, grouping the image files, retrieving the POI metadata from the database and tagging the images taken at the POI.

In another embodiment, a calendar of events is provided for some or all of the POIs in the database. After retrieving the UPOIID, the auto-tagging application checks for an event occurring at this POI during the time when the image of the UPOIID was taken. If there is such an event, its metadata is retrieved from the database and used together with the POI metadata for tagging the images captured at the POI during the specific event.

In yet another embodiment, the POI is provided with an info-tag, which contains the POI metadata. The image of the info-tag, taken by the image capturing apparatus and is then recognized and decoded by the auto-tagging application, thus directly obtaining the POI metadata. If all the POIs contain info-tags, the need for a database record or for a database at all, is eliminated.

### BRIEF DESCRIPTION OF THE SEVERAL VIEWS OF THE DRAWINGS

FIG. 1 is a simplified flow-chart of the process of creation of a UPOIID, the respective database record and of the publishing of a poster containing the UPOIID image

FIG. 1P is a diagram showing prior art—Caplio Pro G3 digital camera with an attached GPS by Ricoh, which is capable of automatic image geo-coding.

FIG. 2 is a simplified flow-chart of the process of creation and publishing of a poster containing an image of the POI metadata

FIG. 2P is a photograph showing prior art—Sony's GPS-CS1 device which is attached to digital cameras and records GPS location information.

FIG. 3 illustrates the process of automatic image data tagging

FIG. 3P is a block diagram illustrating prior art—a system for utilizing local networks to determine the location of digital images, captured by mobile devices capable to connect to the local networks.

FIG. 4 provides an exemplary UPOIID

FIG. 4A provides an exemplary info-tag that contains POI metadata

FIG. 5 illustrates the process of image-data capturing within a POI

FIG. 6 provides an example of a POI poster containing a UPOIID and supporting information

FIG. 7 is a diagram representing a computer network containing multiple host devices (clients) and a remote device

FIG. 8 is a flow-chart diagram showing actions associated with automatic image tagging performed by a digital camera, capable of recognizing the barcode of the UPOIID and connected to communication network, according to one embodiment of the present invention

FIG. 8A is a flow-chart diagram showing actions associated with automatic image tagging performed by a digital camera, capable of recognizing the POI info-tag and reading the POI metadata.

FIG. 9 is a flow-chart diagram showing actions associated with automatic image tagging performed by a host device, connected to communication network, according to one embodiment of the present invention

FIG. 9A is a flow-chart diagram showing actions associated with automatic image tagging performed by a host device, connected to communication network according to one embodiment of the present invention

FIG. 10 illustrates the process of assigning POI and event metadata to images, according to one embodiment of the present invention

FIG. 11 illustrates an example of image-grouping, based on the difference in time between the photographing of adjacent images

FIG. 12 illustrates an example of image auto-tagging, based on the information from a UPOIID image taken in the beginning of the image-taking process at a single POI

FIG. 13 illustrates an example of image auto-tagging, based on the information from a UPOIID image taken during the image taking process at a single POI

FIG. 14 illustrates an example of the auto-tagging of images taken at multiple POIs.

### DETAILED DESCRIPTION OF THE INVENTION

Reference will now be made in detail to the specific embodiments of the invention. Examples of these specific embodiments are illustrated in the accompanying figures. While the invention will be described in conjunction with these specific embodiments, it will be understood that there is no intent to limit the invention to the described embodiments. In the following description, numerous specific details are set forth in order to provide a thorough understanding of the present invention. This does not mean that the present invention cannot be utilized without some of these specific details. On the other hand, apparent operations and functionalities have not been described in detail, in order to avoid obscuring the present invention unnecessarily. It must also be noted here that the terms “picture”, “photograph” and “image file” will be used synonymously throughout the description of the specific embodiments of the present invention.

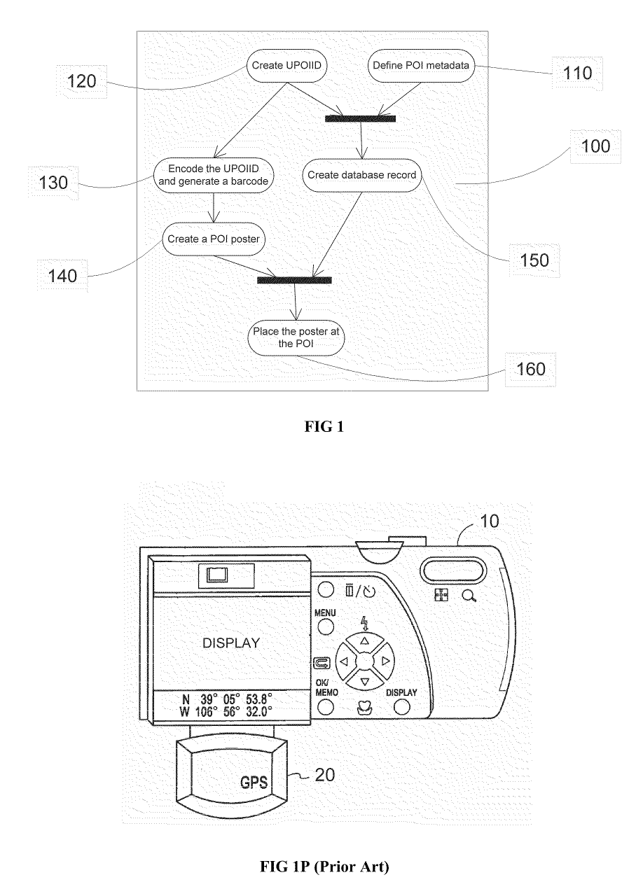

FIG. 1 illustrates the process of creating, encoding and publishing the UPOIID in order to make it publicly accessible for photographing. The first step 120 in this process consists of assigning a unique identifier to a specific POI. Step 110, which is performed concurrently or after step 120, shows the creation of POI metadata, including but not limited to the POI title, description, keywords and geotag. Once the UPOIID and metadata become available, a record in the POI metadata database is created in step 150. The UPOIID is given graphical, machine-readable representation, in the form of a barcode, in step 130. However, it should be understood that the present invention does not limit the ways the UPOIID is represented, to barcodes only. Any type of machine readable representation—including a string of characters—may also be used to distinguish one POI from another. The next step 140 consists of creating a poster depicting the UPOIID barcode. In step 60 the poster is published, so that it becomes easily accessible for photographing by the visitors of the POI.

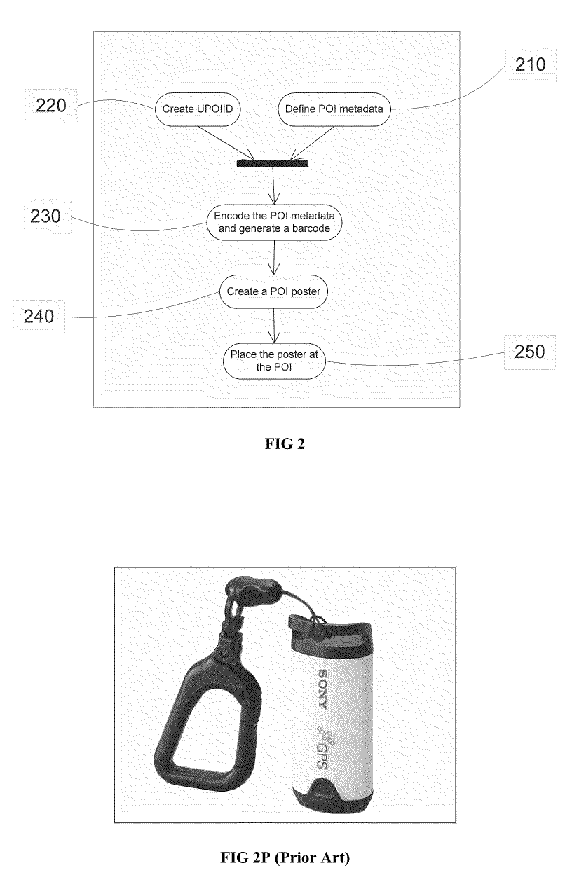

FIG. 2 illustrates another embodiment of the present invention, where the barcode created in step 230 directly encodes the UPOIID and metadata, which is previously defined in steps 210 and 220, respectively. The POI poster is created in step 240 and published in step 250.

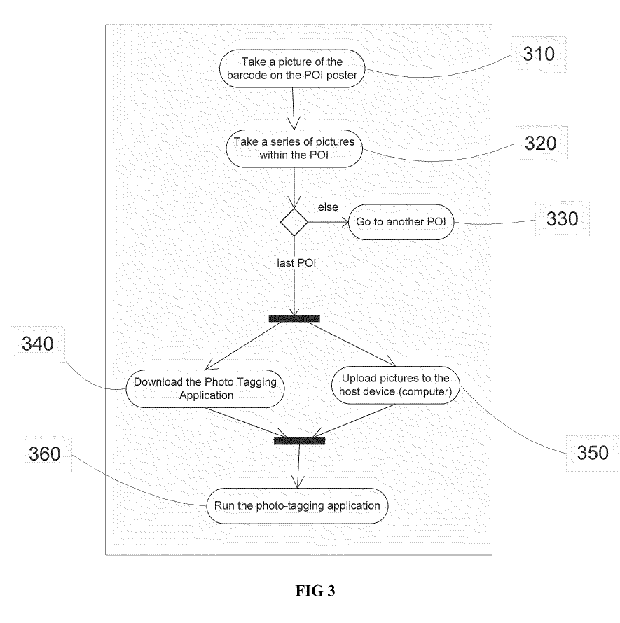

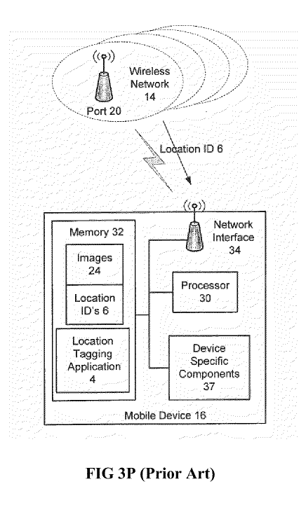

FIG. 3 illustrates the sequence of actions to be performed in order to automatically tag images taken at a single or multiple POI. The first action, performed in step 310, is to take a picture of the barcode of the POI in order to encode the UPOIID or POI metadata. It must be taken into consideration that the action of taking a photograph with a digital camera is simply an exemplary implementation of the method of the present invention. Any type of image capturing apparatus generating image data from the POI barcode can be used instead of a digital camera. After the POI barcode has been captured, a series of pictures are taken within the POI in step 320. Those pictures are stored consecutively in the memory of the image capturing apparatus. In addition to the image data, each image file contains the time and the date when the image was taken. Once the image taking process at single or multiple POI is complete, the pictures are uploaded into a host device (typically a computer), as shown in step 350. The pictures are then processed in step 360 by the automatic photo tagging application, which is downloaded form a dedicated server in step 340 and implements the method of the present invention.

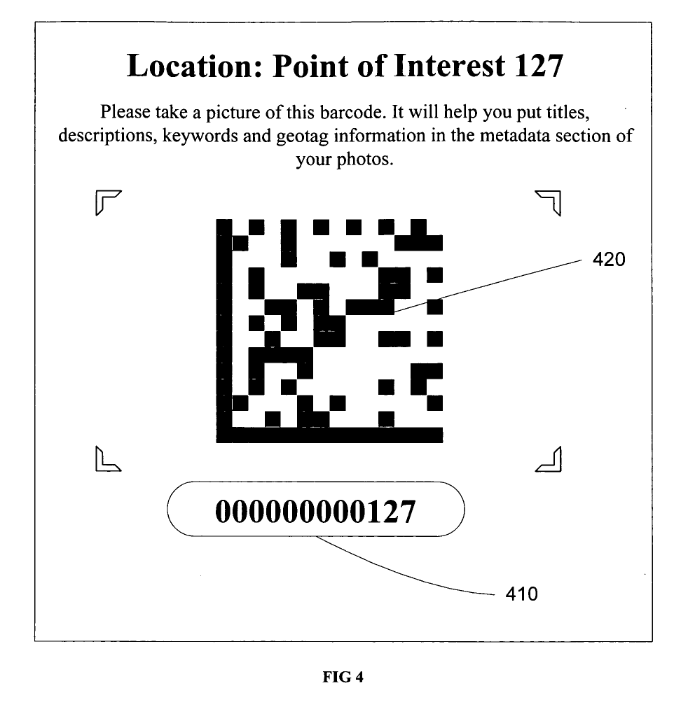

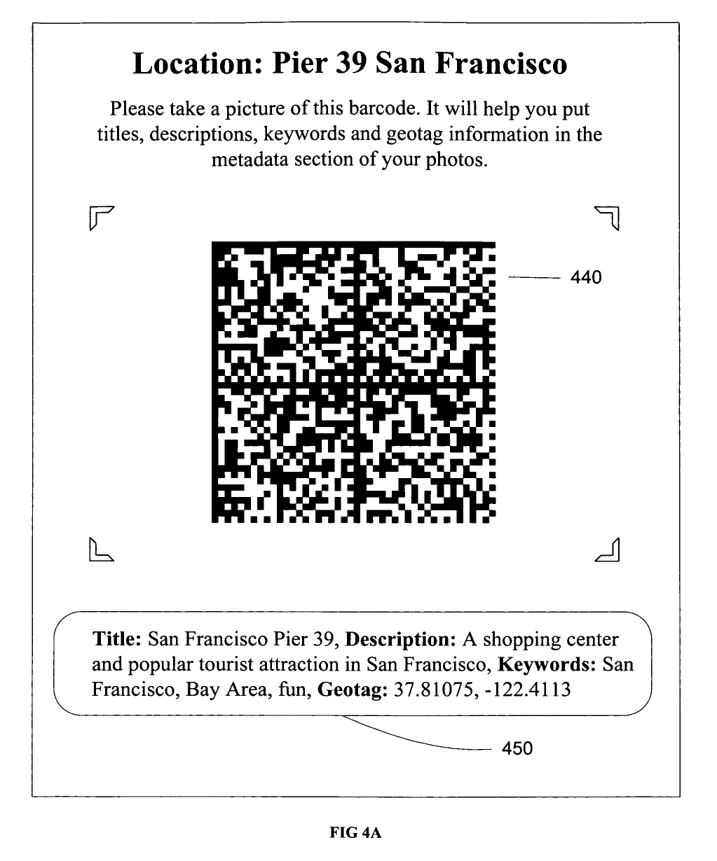

FIG. 4 provides an exemplary two dimensional (2D) barcode 420 of a UPOIID 410.

FIG. 4A illustrates a 2D barcode 440 containing POI metadata 450, used in one embodiment of the present invention, which does not require a database to store the POI metadata (see FIG. 2 above).

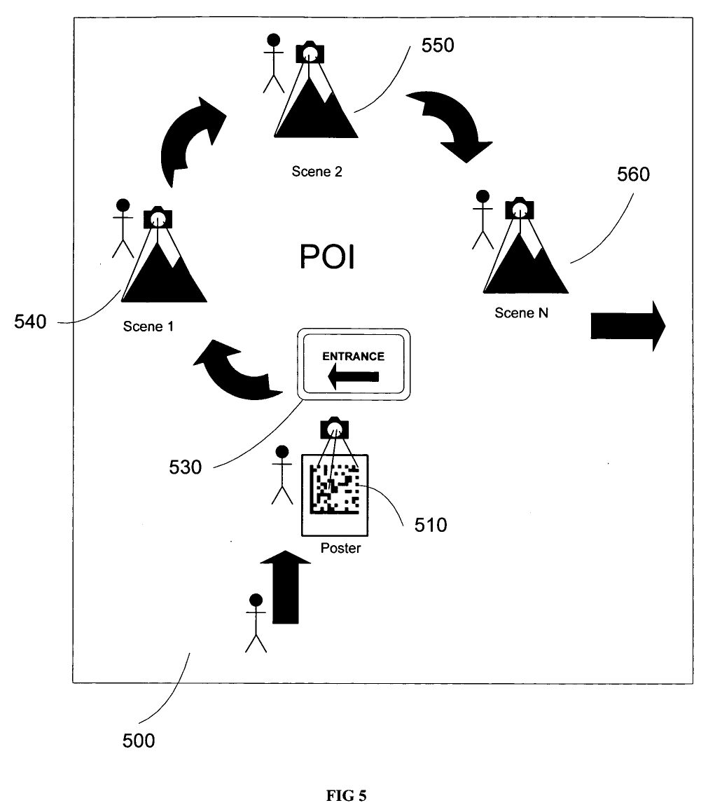

FIG. 5 presents a schematic 500 showing the process of taking pictures within a POI. The poster 520 containing the POI barcode 510 as well as any supporting information is typically placed at the entrance of the POI 530, so the image of the barcode can be photographed first in order for it to precede all other images taken within the POI. A series of pictures are taken during steps 540-560 at Scene 1-Scene N, respectively.

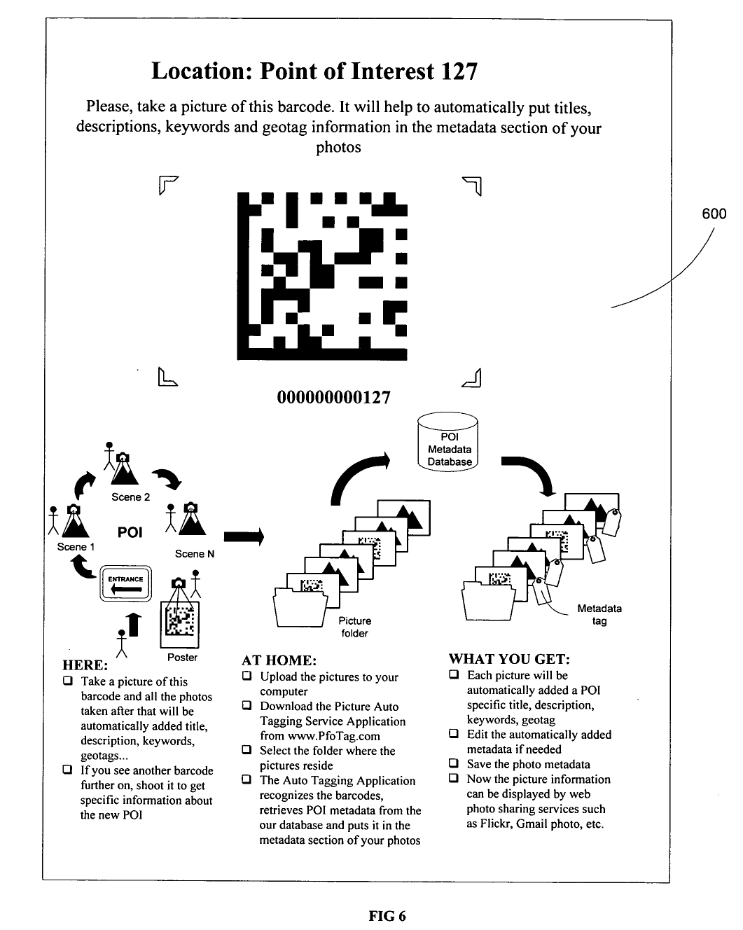

FIG. 6 represents an exemplary poster 600 that contains the UPOIID and guidelines for the user.

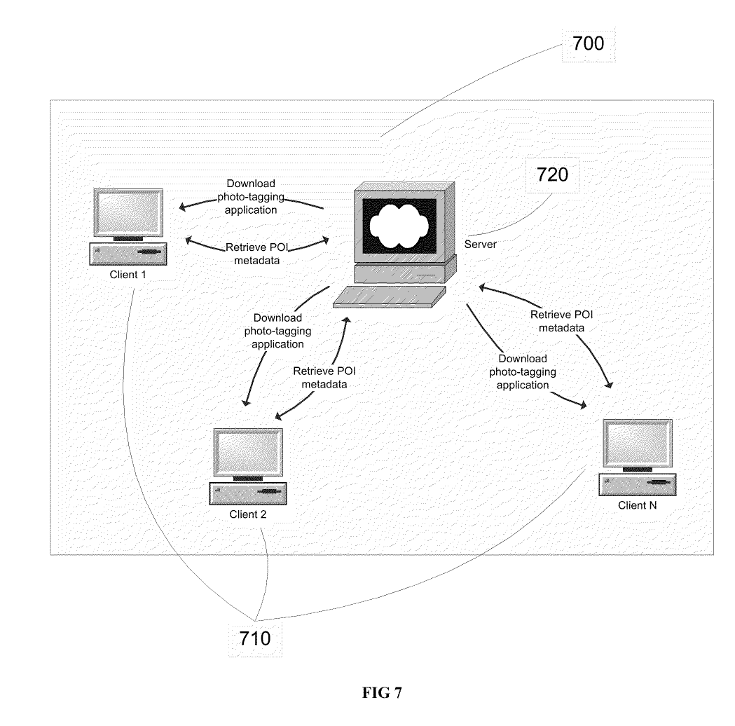

FIG. 7 illustrates a typical network configuration 700 implementing the automatic auto-tagging application, which is subject to the present invention. Each user of the auto-tagging service is a Client 710 that downloads the auto-tagging application from the Server 720. Each Client runs the auto-tagging application, which processes the images previously taken and uploaded from the camera and retrieves POI metadata from the POI metadata database residing in the Server. If implemented in the Microsoft Windows environment, the auto-tagging application can be run as a Windows service, benefiting from all of the advantages of native Windows services. It ensures that the auto-tagging application will (a) run the service at specific time or date; (b) automatically restart in the case of a power failure or application crashes; (c) run at the predefined order (following the service it depends upon); (d) start prior to user logon; and last but not least—be executed with specified user rights and priority.

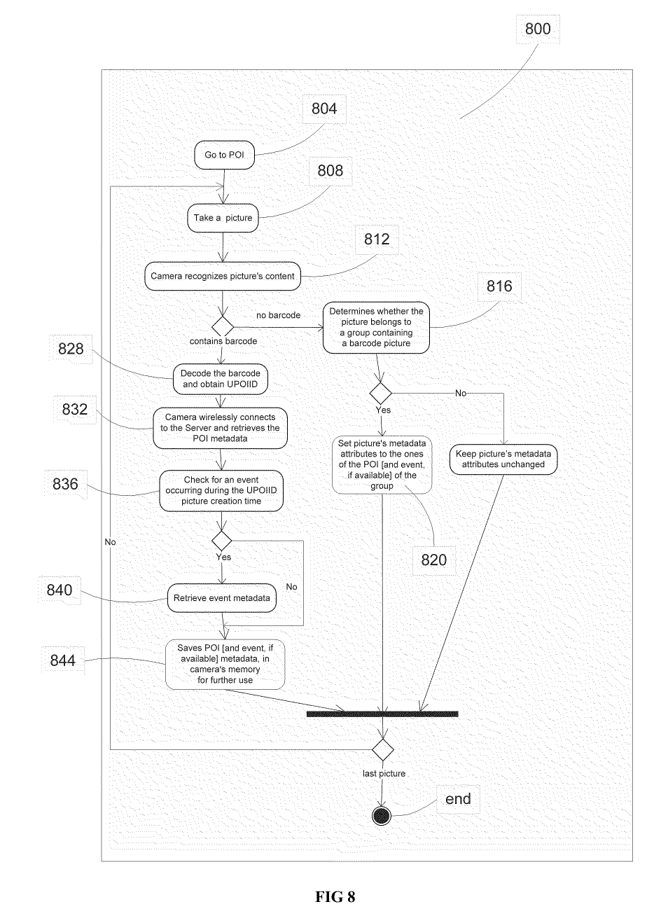

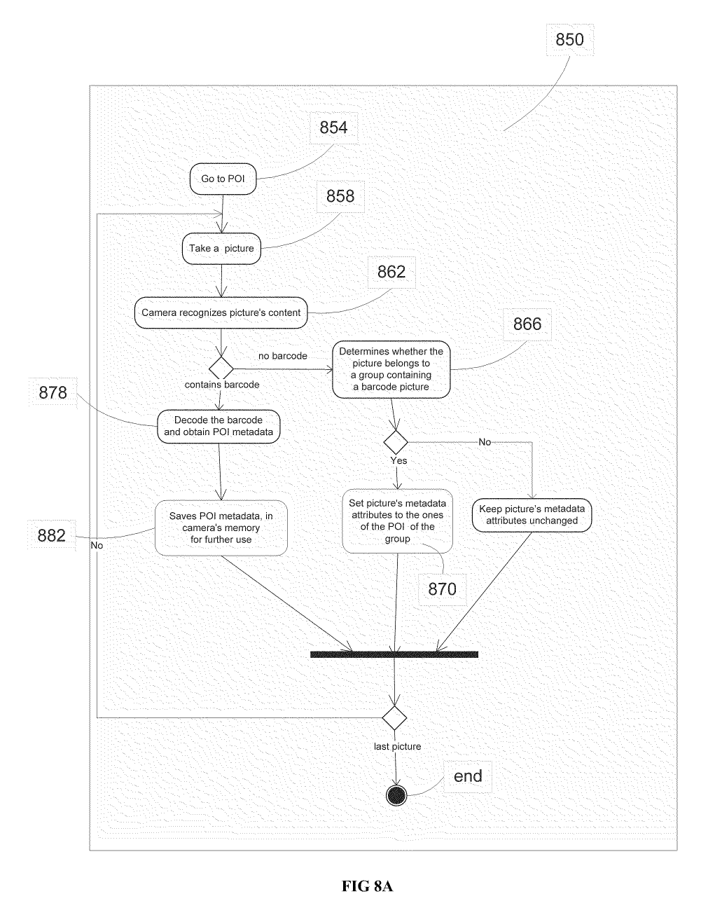

FIG. 8 represents a flow-chart diagram 800 that shows actions associated with automatic image tagging performed by a digital camera, capable of recognizing the barcode of the UPOIID. The one who takes pictures must first go to the specific POI as described in step 804. After the first picture is taken, as shown in step 808, the camera running the auto-tagging application recognizes the picture's content in step 812 and determines whether the image contains a barcode or not. If a barcode is found, the camera decodes the barcode as shown in step 828, wirelessly connects to the server containing the database of POI metadata and retrieves the specific POI metadata, as shown in step 832. In the next step 836, the auto-tagging application checks for an event occurring at the time when the UPOIID picture was taken, and if such an event is found, the application retrieves its metadata from the server, as shown in step 840. In step 844, the POI metadata and the event metadata (if available), are stored in the metadata attributes of the respective image file, which is stored in the camera's memory for further use. If the picture does not contain a UPOIID barcode, the auto-tagging application determines if the picture belongs to a group that contains a barcode picture, as shown in step 816. A group is defined as a plurality of pictures, where the time-difference between the moments at which two adjacent pictures are taken is less than a given time-period. If the picture does not belong to a group containing a UPOIID barcode, then the metadata attributes of the picture remain unchanged. Otherwise, the picture's metadata attributes are set to the ones of the picture containing the metadata of the particular POI (and event, if available), as shown in step 820. The steps described above are repeated until the last picture taken at the POI has been processed.

FIG. 8A represents a flow-chart diagram 850 showing actions associated with automatic image tagging, performed by a digital camera that is capable of reading and recognizing the barcode of the POI, which contains POI metadata. The one who is taking pictures must first go to the specific POI, as described in step 854. After the first picture is taken, as shown in step 858, the camera running the auto-tagging application recognizes the picture content, as shown in step 862, and determines whether the image contains a barcode or not. If a barcode is found, the camera decodes the barcode and obtains the POI metadata, as shown in step 878. In step 882, the POI metadata and the event metadata (if available), are stored in the metadata attributes of the respective image file, which is stored in the camera's memory for further use. If the picture does not contain a barcode, the auto-tagging application determines if the picture belongs to a group that contains a barcode picture, as shown in step 866. If the picture does not belong to a group containing a barcode, then the metadata attributes of the picture remain unchanged. Otherwise, the picture's metadata attributes are set to the ones of the picture containing the metadata of the particular POI, as shown in step 870. The steps described above are repeated until the last picture taken at the POI has been processed.

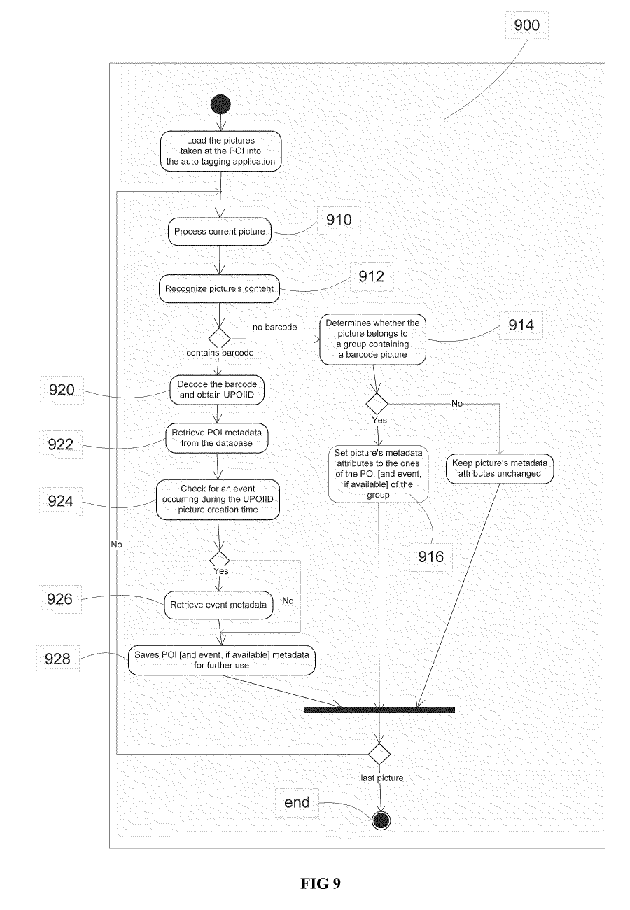

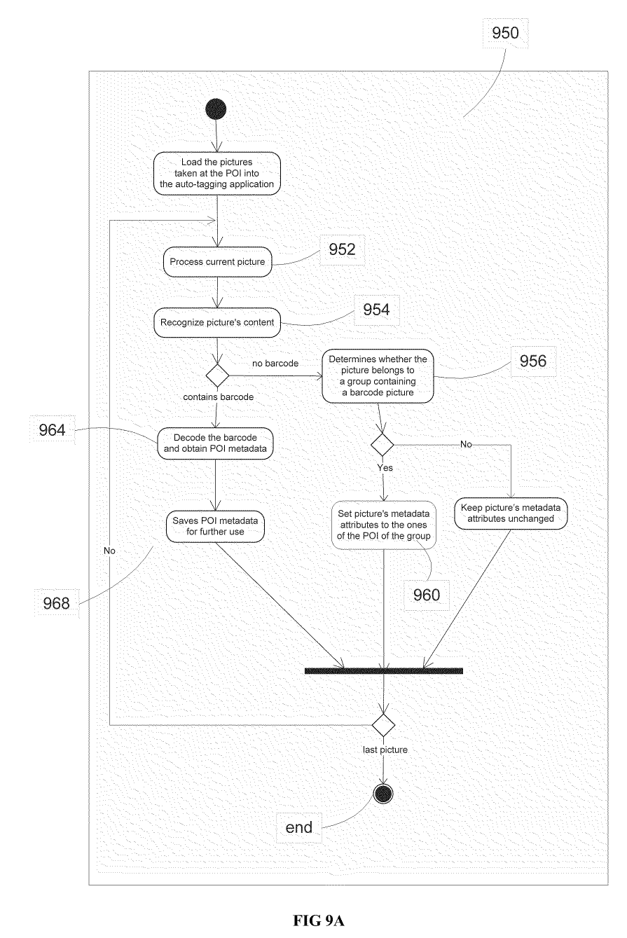

FIG. 9 represents a flow-chart diagram 900 that shows actions associated with automatic image tagging performed by the auto-tagging application running on a host device (a computer). The pictures taken at a specific POI are uploaded from the camera into a dedicated folder on the host device. The auto-tagging application then loads all the pictures from the folder. The application processes the first (current) picture, as shown in step 910 and recognizes its content, as shown in step 912. It then determines whether the image contains a barcode or not. If a barcode is found, the application decodes the barcode and obtains the UPOIID, as shown in step 920. By using the UPOIID, the application retrieves the POI metadata from the database residing on the server, as shown in step 922. In the next step 924, the auto-tagging application checks for an event occurring at the time when the UPOIID picture was taken, and if such an event is found, the application retrieves its metadata from the server, as shown in step 926. In step 928, the POI metadata and the event metadata (if available), are stored in the metadata attributes of the respective image file. If the picture does not contain a UPOIID barcode, the auto-tagging application determines if the picture belongs to a group that contains a barcode picture, as shown in step 914. If the picture does not belong to a group containing a UPOIID barcode, then the metadata attributes of the picture remain unchanged. Otherwise, the picture's metadata attributes are set to the ones of the picture containing the metadata of the particular POI (and event, if available), as shown in step 916. The steps described above are repeated until the last picture taken at the POI has been processed.

FIG. 9A represents a flow-chart diagram 950 that shows actions associated with automatic image tagging performed by the auto-tagging application running on a host device (a computer). The pictures taken at a specific POI are uploaded from the camera into a dedicated folder in the host device. The auto-tagging application then loads all the pictures from the folder. The application processes the first (current) picture, as shown in step 952 and recognizes its content, as shown in step 954. It then determines whether the image contains a barcode or not. If a barcode is found, the application decodes the barcode, as shown in step 964, and obtains the POI metadata directly from it. In step 968, the obtained POI metadata is stored in the metadata attributes of the respective image file. If the picture does not contain a UPOIID barcode, the auto-tagging application determines if the picture belongs to a group that contains a barcode picture, as shown in step 956. If the picture does not belong to a group containing a UPOIID barcode, then the metadata attributes of the picture remain unchanged. Otherwise, the picture's metadata attributes are set to the ones of the picture containing the metadata of the particular POI, as shown in step 960. The steps described above are repeated until the last picture taken at the POI has been processed.

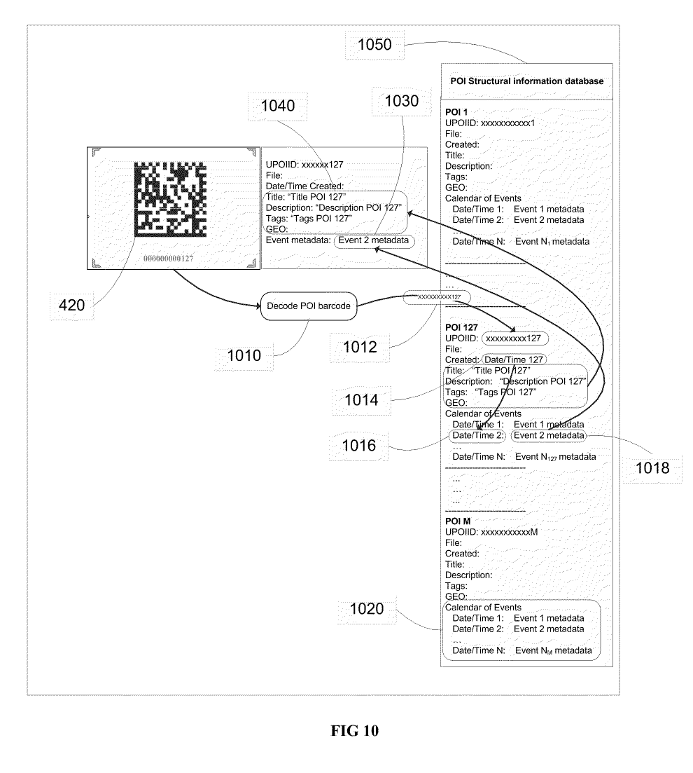

FIG. 10 illustrates the mechanism of assigning POI and event metadata to images, according to one embodiment of the present invention. After the barcode 420 is decoded in step 1010, the obtained UPOIID 1012 is used to uniquely identify the record in the database 1050, containing the POI metadata. The database 1050 may contain a calendar of events 1020 for some or for all POI. The date and time 1014 of creation of the UPOIID image is an attribute of the POI metadata. The database record of the specific POI may or may not contain a calendar of events occurring at the POI. If such a calendar exists, the auto-tagging application checks if the date and time 1014 match up with a date and time in the calendar of events. If such a match 1016 exists, the event metadata 1018 along with the POI metadata 1017 are stored in the respective metadata attributes 1030 and 1040 of the UPOIID image file. The POI metadata 1040 and the event metadata 1030 are then further used to automatically tag other images taken at the POI, as shown in the embodiment of the present invention illustrated by FIG. 9.

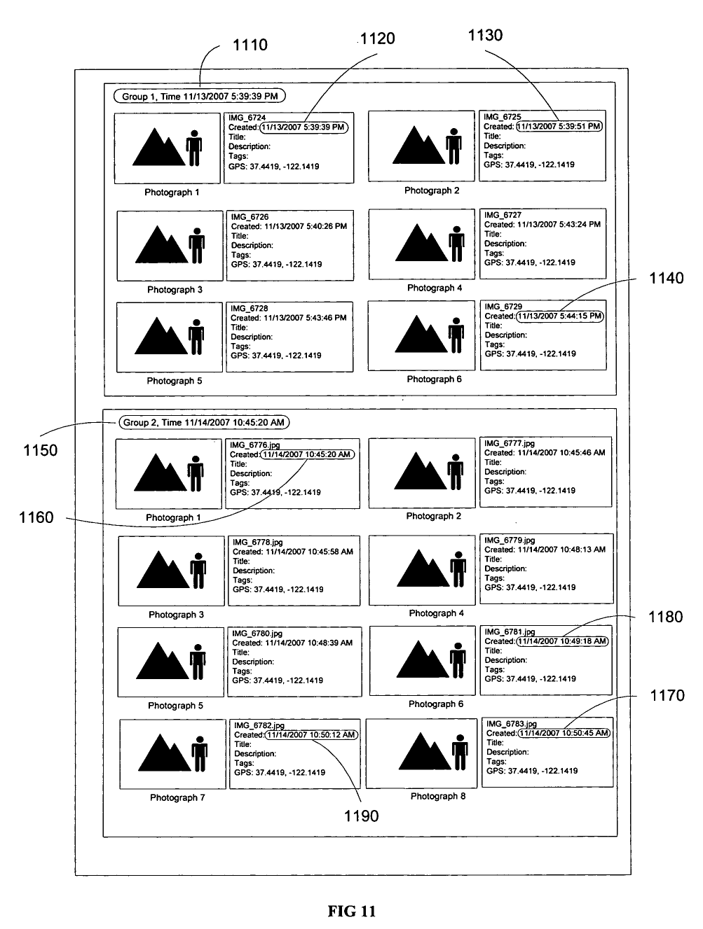

An inherent part of the method that is subject to the present invention, is organizing image files into groups. A group, according to the method of the present invention, is a plurality of pictures, wherein the time-difference between the moments every two adjacent pictures are taken is less than a given time-period. Each group can contain a picture of the UPOIID of the POI where the plurality of pictures is taken. After the metadata of the POI has been obtained, as described in the embodiments above, it is assigned to the pictures from the group. FIG. 11 shows two groups of pictures and illustrates the picture grouping rule. Each group has its own identifier—1110 for the first group and 1150 for the second group. Each group identifier, e.g. 1110, shows the date and time of the first picture of the group, e.g. 1120. The difference between the moments at which every two adjacent pictures in a group were taken is less than a specified time-period, which is used as a criterion for the time-based picture grouping. In the particular example shown in FIG. 11, the time-period is defined to be one hour. It must be understood however, that this time-period could be defined differently depending on POI-specific circumstances, such as the maximum time it would take for the photographer to move from one spot in the POI to another or the number of locations that present an interest within the POI, which determine the frequency of taking pictures in the POI. For example, it is very unlikely for two adjacent pictures to be taken within one and the same POI if their date and time differ significantly, e.g. by more than a day. By analyzing the date and time of the pictures from both groups, it is seen that the maximum time-difference between the moments at which every two adjacent pictures were taken is 2 m and 58 sec. for the first group, and 2 min and 15 sec. for the second group. The time between the moment 1160 at which the first picture of the second group was taken and the moment 1140 at which the last picture of the first group was taken is 17 hours and 1 min, which by far exceeds the one hour that is used as a criterion.

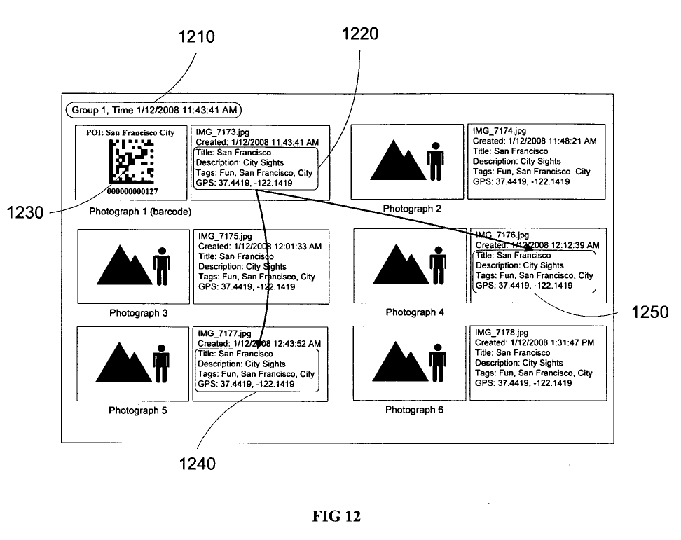

FIG. 12 shows a group of pictures 1210 taken at a specific POI, where the first picture taken at the POI is the one of the UPOIID barcode 1230. After recognizing the barcode and retrieving the POI metadata 1220 from the database, as described above, the metadata 1220 is assigned to all of the pictures from the group, e.g. 1240, 1250, etc.

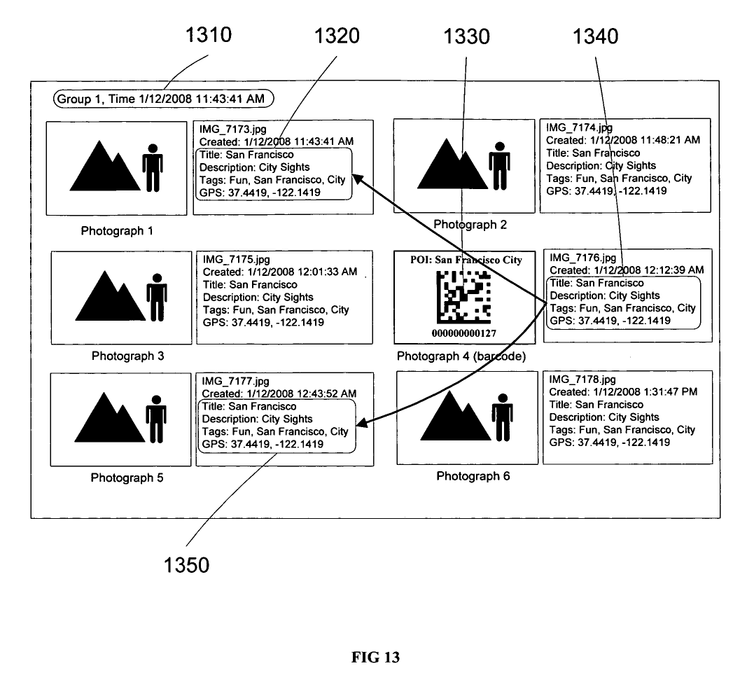

FIG. 13 represents a similar picture organization scenario, in which the picture 1330 of the UPOIID barcode is not the first picture in the group 1310. After recognizing the UPOIID barcode and retrieving the POI metadata 1340 from the database, the metadata 1340 is assigned to all of the pictures from the group, e.g. to 1320, 1350, etc.

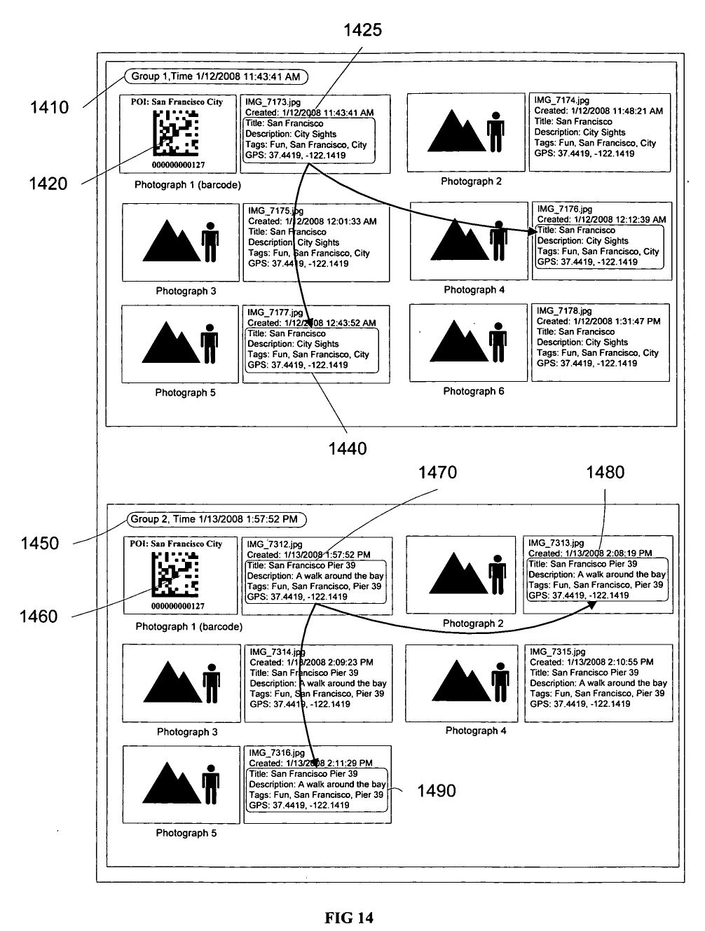

FIG. 14 represents an example of picture grouping and tagging, where the picture folder contains two barcode images—1420 and 1460. This automatically divides the pictures from the folder into two groups, 1410 and 1450, starting with the barcode pictures, since only one barcode picture is allowed in a group. After recognizing the barcodes 1420 and 1460 and retrieving the respective POI metadata 1425 and 1470 from the database, the metadata 1425 gets assigned to all of the pictures, e.g. 1430, 1440, etc. from the first group 1410, and the metadata 1470, to all the pictures, e.g. 1480, 1490, etc. from the second group.

1. A method of automatically tagging image data, each image data being captured at a physical location, representing a point of interest (POI), each image data is stored in an image file, each image file also containing image metadata, comprising:
providing an image capturing apparatus, the image capturing apparatus comprising locations for storing image files;
providing an unique POI identifier (UPOIID);
representing the UPOIID in a physical form that is readable by the image capturing apparatus;
making the UPOIID accessible for reading by the image capturing apparatus;
providing a database containing metadata about a plurality of POI, including said POI;
capturing a plurality of image data, including the image data of the UPOIID, by the image capturing apparatus and storing the image files in the image capturing apparatus locations;
recognizing the image data of the UPOIID;
decoding the image data of the UPOIID and obtaining the UPOIID;
retrieving metadata from the database about the POI based on its UPOIID;
grouping image files, in such a way that each group consists of a plurality of image files, containing image data captured consecutively in time, wherein every two adjacent image data being captured with time-difference less than a specified time-interval, and each group contains image data of only one UPOIID;
tagging image data by transferring the retrieved POI metadata to the image files of the group that the image file of the UPOIID belongs to.

2. The method of claim 1 further comprising:
providing host computer means for storing image files generated by the image capturing apparatus, the host computer means coupled to a communication network;
providing remote computer means for hosting the database, the remote computer means coupled to the communication network;
uploading image files from the image capturing apparatus to the host computer means; and
wherein the steps of recognizing, decoding, retrieving, grouping and tagging are performed by the host computer means.

3. The method of claim 2, wherein the image capturing apparatus is a digital camera or a camera phone or a video recorder, and the image data is a digital photograph or a video.

4. The method of claim 3, wherein capturing image data is taking photographs or recording a video.

5. The method of claim 2, wherein the image capturing apparatus locations are memory locations, hard disk-drive locations or a combination of both.

6. The method of claim 2, wherein the physical form of representation of the UPOIID is a barcode.

7. The method of claim 2, wherein the communication network is Internet.

8. The method of claim 2 comprising a plurality of host computer means (Clients) and at least one remote computer means (Server).

9. The method of claim 2 further comprising:
providing a calendar of events, comprising event metadata for some or all of the POI in the database;
retrieving event metadata, for event(s) occurring at said POI on the date and time the POI image data was taken, from the calendar of events;
tagging image data by transferring the event metadata to the image files of the group that the image file of the UPOIID belongs to.

10. The method of claim 1 further comprising:
providing a remote computer means for hosting the database, the remote computer means coupled to the communication network; and
wherein the steps of decoding, grouping, retrieving and transferring are performed by the image capturing apparatus, which is connected to the communication network.

11. The method of claim 10, wherein the image capturing apparatus is a digital camera or a camera phone or a video recorder, and the image data is a digital photograph or a video.

12. The method of claim 10, wherein capturing image data is taking photographs or recording a video.

13. The method of claim 10, wherein the image capturing apparatus locations are memory locations, hard disk-drive locations or a combination of both.

14. The method of claim 10, wherein the physical form of representation of the UPOIID is a barcode.

15. The method of claim 10, wherein the communication network is Internet.

16. The method of claim 10 further comprising:
providing a calendar of events, comprising event metadata for some or all of the POI in the database;
retrieving event metadata, for event(s) occurring at said POI on the date and time the POI image data was taken, from the calendar of events;
tagging image data by transferring the event metadata to the image files of the group that the image file of the UPOIID belongs to.

17. A method of automatically tagging image data, each image data being taken at a physical location, representing a POI, each image data is stored in an image file, each image file also containing image metadata, comprising:
providing an image capturing apparatus, the image capturing apparatus comprising locations for storing image files;
providing an info-tag of the POI represented in a physical form that is readable by the image capturing apparatus, the info-tag comprising metadata about the POI;
making the POI info-tag accessible for reading by the image capturing apparatus;
capturing a plurality of image data by the image capturing apparatus, including the image data of the POI info-tag, and storing the image files in the image capturing apparatus locations;
recognizing the image data of the POI info-tag;
decoding the image data of the POI info-tag thus obtaining the POI metadata;
grouping image files, in such a way that each group consists of a plurality of image files, containing image data captured consecutively in time, wherein every two adjacent image data being captured with time-difference less than a specified time-interval, and each group contains image data of only one POI info-tag;
tagging image data by transferring the POI metadata to the image files of the group that the image file of the POI info-tag belongs to.

18. The method of claim 17 further comprising:
providing a host computer means for storing image files generated by the image capturing apparatus, the host computer means coupled to a communication network;
uploading image files from the image capturing apparatus to the host computer means; and
wherein the steps of recognizing, decoding, grouping, and tagging are performed by the host computer means.

19. The method of claim 18, wherein the image capturing apparatus is a digital camera or a camera phone or a video recorder, and the image data is a digital photograph or a video.

20. The method of claim 18, wherein capturing image data is taking photographs or recording a video.

21. The method of claim 18, wherein the image capturing apparatus locations are memory locations, hard disk-drive locations or a combination of both.

22. The method of claim 18, wherein the physical form of representation of the POI info-tag is a barcode.

23. The method of claim 18, wherein the communication network is Internet.
